(19) United States
(12) Patent Application Publication
(10) Pub. No.: US 2010/0328200 A1
(43) Pub. Date: Dec. 30, 2010

(54) Device and related method for converting display screen into touch panel screen

(76) Inventors: Chi-Chang Yu, Keelung City (TW); Chih-Yang Tzeng, Taipei County (TW); Homer H. Chen, Taichung City (TW); Meng-Chun Lin, Taipei City (TW); I-Hau Yeh, Hsinchu City (TW); Hong-Cheng Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/822,187

(22) Filed: Jun. 24, 2010

(30) Foreign Application Priority Data
Jun. 30, 2009 (TW) 098122038

(51) Int. Cl. G06F 3/033

(52) U.S. Cl. 345/156

(57) ABSTRACT

A device for converting display screen into touch panel screen includes a projection screen; an image projection unit for projecting an image on the projection screen; a light pointer for emitting a light spot signal of a specific wavelength on the projection screen; an image detecting unit, which includes a fisheye lens for receiving the image on the projection screen to generate a fisheye distorted image; and an optical filter for filtering out the optical energy except the light spot signal of the specific wavelength; an image processing unit, coupled to the image detecting unit, for calculating a first position of the light spot on the projection screen according to the fisheye distorted image; and a message transmitting unit, coupled to the image processing unit, for outputting a touch panel signal according to the calculating result of the image processing unit.

### BACKGROUND OF THE INVENTION

1. Field of the Invention

The present invention relates to a device and related method for converting a display screen into a touch panel screen, and more particularly, to an optical device and related method which can make the device operated in a short distance from the projection screen.

2. Description of the Prior Art

In recent years, display devices with touch panel functions are getting more popular. With a traditional touch panel screen, users may simply use their finger tips to touch control buttons displayed on the touch panel screen and have the host computer perform the selected functions. However, the screen size of a traditional touch panel display device is relatively too small for presentation to a large audience. Besides, a large touch panel screen, if possible to make at all, is costly. To address this problem, a light pointing device can be used together with a large display screen to provide the touch function, for which the display can be a projector screen or an LCD or CRT screen. In the case of a projector screen, the light pointing touch panel display device uses a projector to project an image on the projection screen, whose size can be relatively large, and a light pointer to operate in front of the projection screen. The light pointer is a light source which can generate a light spot on the projection screen, and the light spot is used to select the control buttons on the projection screen. In other words, if the user wants to execute a certain control function, the user can operate the light pointer and project the light spot on the control button corresponding to the selected control function. In parallel with this operation, a camera capable of detecting the light spot is utilized to photograph the light spot and detect the position of the light spot with respect to the projected image. After the light spot is detected, the camera can transmit a message including the position information of the light spot to a host computer so that the host computer is aware that a certain control button has been selected. By doing so, the display device emulates the touch panel function of the traditional touch panel display device and provides a new kind of user experience similar to that of the traditional touch panel screen.

Please refer to FIG. 1, which illustrates a schematic diagram showing the functions of a light pointing touch panel display device 10. The light pointing touch panel display device 10 includes a projection screen SCRN1, a light pointer LSIG1, a projector PROJ1 and a small viewing angle camera NVCAM1. The operations of the light pointing touch panel display device 10 can be described as follows: The projector PROJ1 may project an image PIC1 on the projection screen SCRN1, and the operator OP1 operates the light pointer LSIG1 to project a light spot at a position POS0 on the projected image PIC1. Meanwhile, the small viewing angle camera NVCAM1 installed in front of the projection screen SCRN1 may photograph the projected image PIC1, and calculate the position POS0 of the light spot in the projected image PIC1. Furthermore, there may be one or more control buttons BUTTON_1˜BUTTON_n on the projected image PIC1, which correspond to some control commands COMMAND_1˜COMMAND_n of a host computer HOST1, respectively. When the user intends to execute a specific control command COMMAND_x, the user only needs to point the light pointer LSIG1 to the control button BUTTON_x and project a light spot on it, the small viewing angle camera NV can constantly detect the projection screen and calculate the position POS0 of the light spot in the projected image PIC1, and output a message containing the position POS0 information of the light spot to the host computer HOST1 to decide which one of the control commands COMMAND_1˜COMMAND_n corresponds to the position POS0, so the corresponding control command COMMAND_x can be executed.

Generally, the light pointer LSIG1 produces lights both in the visible and invisible range, and the visible light is most often the red light. Since the red light is visible, it is convenient for the user(s) to observe the current position of the light spot. On the other hand, the visible light is filtered out by an optical filter installed on the small viewing angle camera NVCAM1 to let pass the invisible light only, such that the visible light does not disturb the detection of the light spot, and so the position POS0 of the light spot on the projected image PIC1 can be calculated.

Noteworthily, the method for estimating a pointing position POS0 of the prior art is more straightforward and simple. For example, please refer to FIG. 2A, which illustrates a schematic diagram of a projection screen PIC1 containing a projected light spot in the position POS0. Firstly, the operating modes of the light pointing touch panel display device 10 can be classified further into a calibrating mode and a normal mode, and the light pointing touch panel display device 10 can be assisted by a user OP1 to complete the operating procedure for calibration purposes in the calibrating mode. Simply speaking, the calibrating mode of the light pointing touch panel display device 10 is to help the user to follow the instructions given by the host computer HOST1, and to use the light pointer LSIG1 to mark the positions Corn_1˜Corn_4 corresponding to the four corners of the projected image PIC1 on the projected screen SCRN1, and have the small viewing angle camera NVCAM1 to record the sensing positions CNS_1˜CNS_4 corresponding to the positions Corn_1˜Corn_4. After the small viewing angle camera NVCAM1 has completed the procedure for the calibrating mode, it will enter the normal mode and get ready for user's operation. Please refer to FIG. 2B, which illustrates a schematic diagram of an image 20 containing a light spot located in PSS0 taken by the small viewing angle camera NVCAM1. While in the normal mode, the light pointing touch panel display device 10 can detect the position of the light spot and use a linear proportional method in the two-dimensional (2D) coordinate system to calculate a two dimensional coordinates for the light spot. The method of calculating the coordinates of the light spot in the light pointing touch panel display device 10 is well known to people with common knowledge in the art, and will not be detailed hereafter. Simply speaking, since the optics of the small viewing angle camera NVCAM1 is relatively simple, the detected image won't be distorted or the distortions of the detected image are negligible, so the coordinate of the light spot in the POS0 can be determined easily, and the accuracy of the detection result is acceptable in general.

Since the viewing angle of the small viewing angle camera is relatively small, the detected images has little or negligible distortions. However, this may cause a serious problem that, when detecting at a relatively short projecting distance, the small viewing angle camera NVCAM1 can't cover the entire picture on the projection screen, and only a small portion of the projected image falls within the field of view of the small viewing angle camera NVCAM1, such that the system can't work properly. Therefore, the operating distance of the light pointing touch panel display device 10 is severely restricted. In other words, the operating distance should be long enough such that the entire projected image can be detected by the camera NVCAM1. Please refer to FIG. 3, which illustrates a schematic diagram of a projected image detected by the small viewing angle camera NVCAM1 while operating in a relatively short projecting distance. As can be understood from FIG. 3, because the projecting distance is too short, the small viewing angle camera NVCAM1 can only cover a portion of the projection screen PIC1, or even a small portion of it, some of the control buttons BUTTON_1˜BUTTON_n may be located outside the field of view of the small viewing angle camera NVCAM1. Therefore, when the user OP1 uses the light pointer LSIG1 to mark the control buttons BUTTON_1˜BUTTON_n, the light spot signal could fall outside of the viewing angle of the small viewing angle camera NVCAM1, such that the light pointing touch panel display device 10 cannot function correctly.

### SUMMARY OF THE INVENTION

It is therefore the primary objective of the present invention to provide a light pointing touch panel display device and related detecting method.

The claimed invention discloses a light pointing touch panel display device, which comprises a projection screen; an image projection unit for projecting an image on the projection screen; a light pointer for emitting a light spot signal of a specific wavelength on the projection screen; an image detecting unit, which comprises a fisheye lens for receiving the image on the projection screen to generate a fisheye distorted image; and an optical filter for filtering out the optical energy except the light spot signal of the specific wavelength; an image processing unit, coupled to the image detecting unit, for calculating a first position of the light spot on the projection screen according to the fisheye distorted image; and a message transmitting unit, coupled to the image processing unit, for outputting a touch panel signal according to the calculating result of the image processing unit.

The claimed invention further discloses a light pointing touch panel detecting method, which comprises projecting an image on a projection screen; emitting a light spot signal of a specific wavelength on the projection screen; receiving the image on the projection screen to generate a fisheye distorted image; filtering out optical energy except the light spot signal of the specific wavelength; calculating a first position of the light spot on the projection screen according to the fisheye distorted image; and outputting a touch panel signal according to the calculating result of the image processing unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram showing the functions of a light pointing touch panel display device of the prior art.

FIG. 2A illustrates a schematic diagram of a projection screen containing a projected light spot in a position shown in FIG. 1.

FIG. 2B, which illustrates a schematic diagram of an image containing a light spot located in a position taken by the small viewing angle camera.

FIG. 3 illustrates a schematic diagram of a projected image detected by the small viewing angle camera while operating in a relatively short projecting distance.

FIG. 4A illustrates a schematic diagram showing the functions of a light pointing touch panel display device according to an embodiment of the present invention.

FIG. 4B illustrates a functional block diagram of the light pointing touch panel display device shown in FIG. 4A according to an embodiment of the present invention.

FIG. 4C illustrates a schematic diagram of an image processing unit according to an embodiment of the present invention.

FIG. 5A illustrates a schematic diagram of an image before being corrected by the keystone correction coordinate transformation.

FIG. 5B illustrates a schematic diagram of an image after being corrected by the keystone correction coordinate transformation according to FIG. 5A.

FIG. 6 illustrates a schematic diagram of a light pointing touch panel detecting process according to an embodiment of the present invention.

FIG. 7 illustrates a process utilized to calculate a position of a light spot SPOS on a fisheye corrected image according to a fisheye distorted image.

FIG. 8A illustrates a schematic diagram of a fisheye distorted image detected by an image detecting unit.

FIG. 8B illustrates a fisheye corrected image, which is corrected according to FIG. 7 by an image processing unit, according to an embodiment of the present invention.

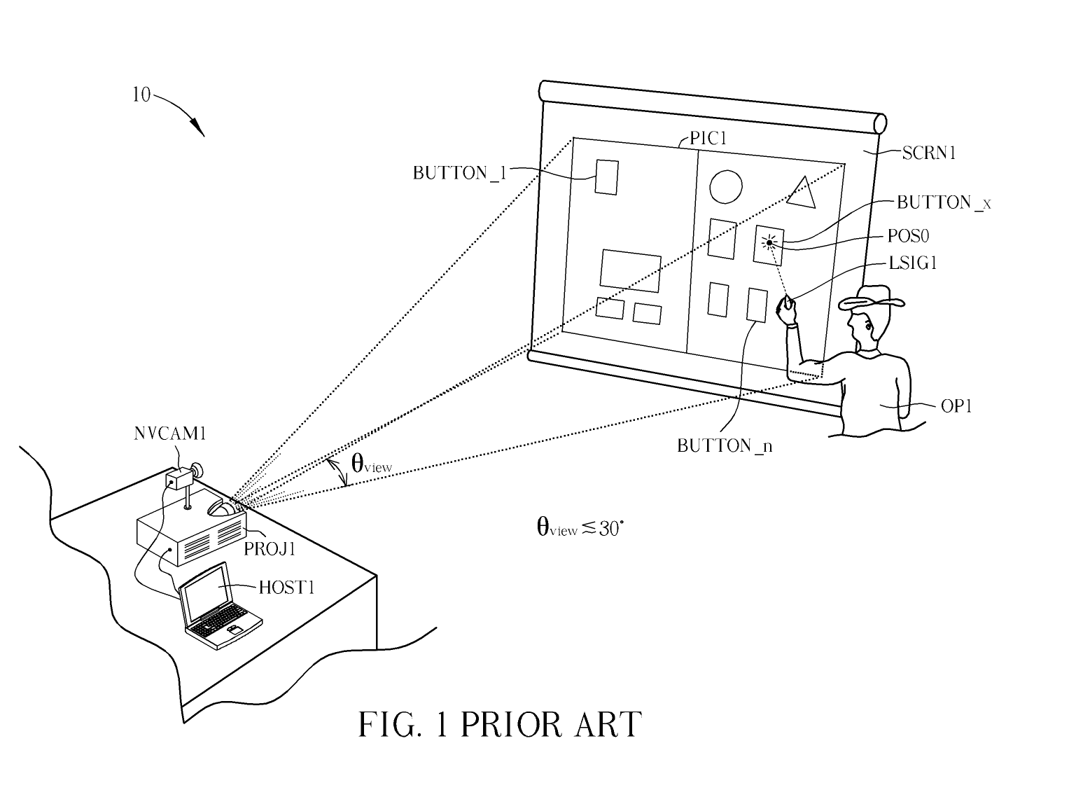

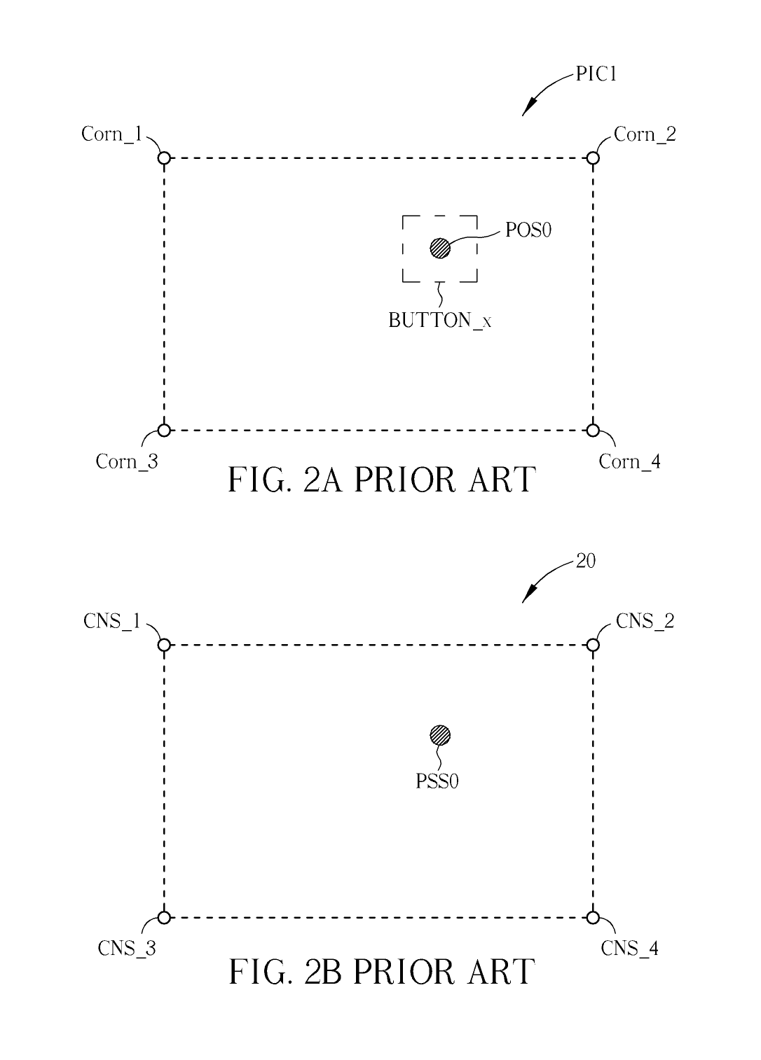

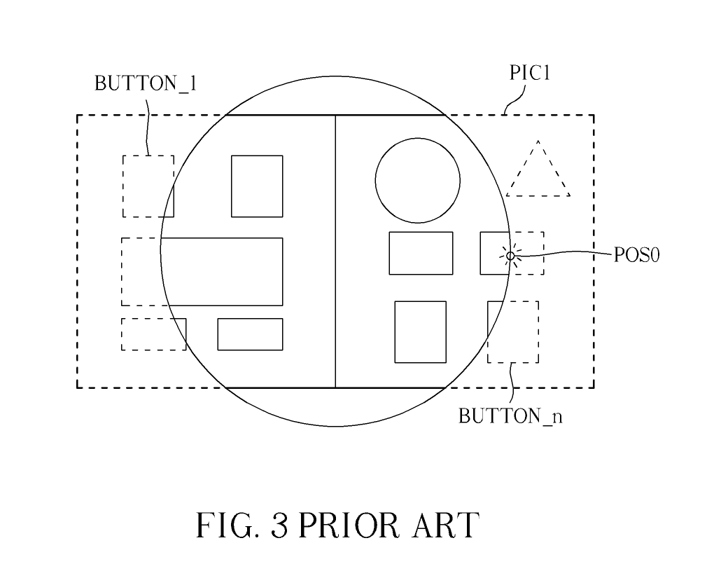

### DETAILED DESCRIPTION

As stated above, the light pointing touch panel display device 10 of the prior art utilizes the small viewing angle camera NVCAM1, which has serious limitations on the operating distance. When the camera NVCAM1 is photographing the projected images in a short distance, the operating distance can be too short for the small viewing angle camera NVCAM1 to cover the whole projected image, such that the touch panel function does not work normally. To overcome this, the present invention refers to the concept proposed by one of the inventors of the present invention, which is disclosed in the U.S. patent application Ser. No. 12/428,478, and to utilize a fisheye camera of large viewing angle to replace the small viewing angle camera NVCAM1, and to construct the related algorithm to process the detected fisheye distorted images. Furthermore, since the projected image is often accompanied with a geometrical distortion called perspective distortion, the present invention has established a keystone distortion correction function to correct specifically the perspective distortion, such that the accuracy of the detecting result can be improved further. The operating principles of the present invention are disclosed as follows:

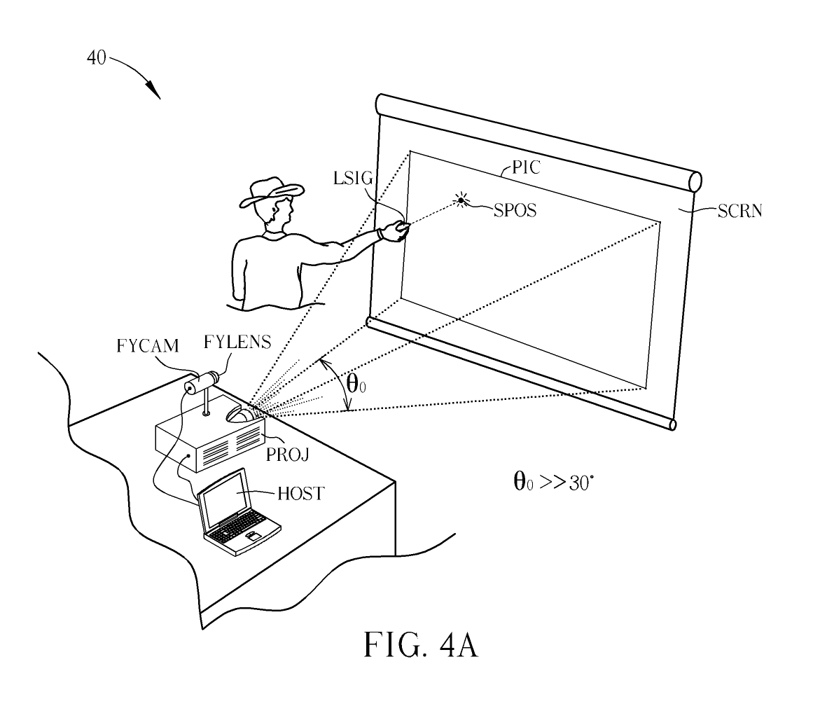

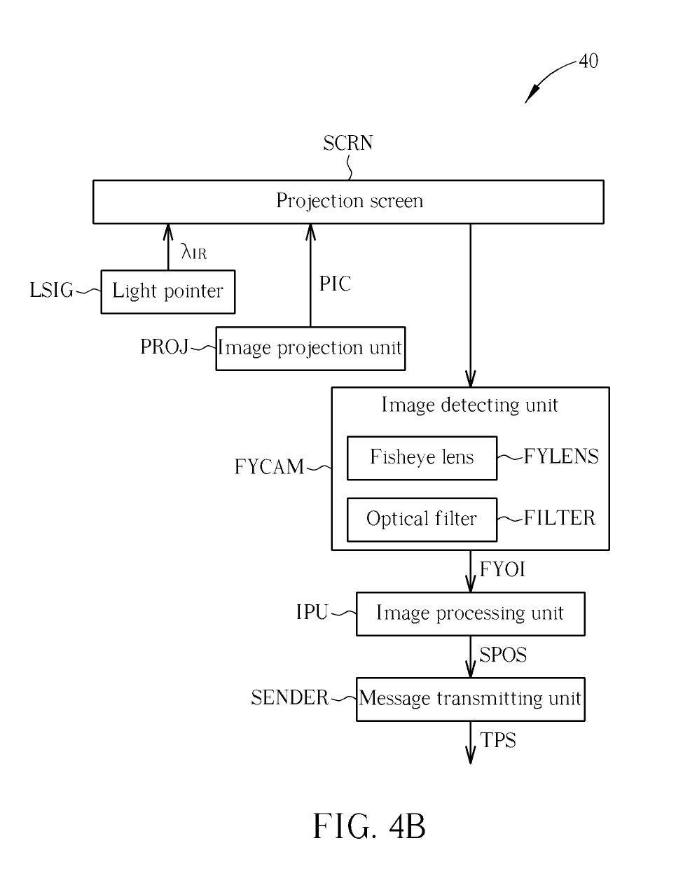

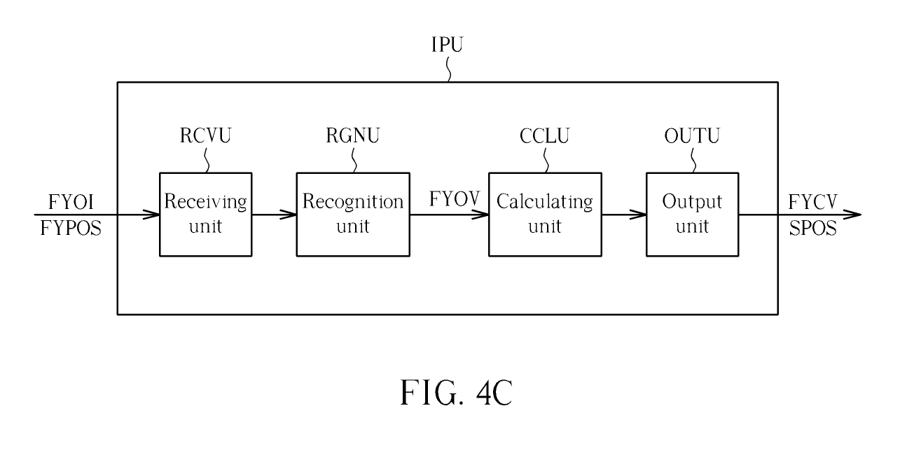

Please refer to FIG. 4A, which illustrates a schematic diagram showing the functions of a light pointing touch panel display device 40 according to an embodiment of the present invention. Inside FIG. 4A, the projecting distance of the light pointing touch panel display device 40 can be much shorter than the projecting distance of the light pointing touch panel display device 10 of the prior art. Next, please refer to FIG. 4B, which illustrates a functional block diagram of the light pointing touch panel display device 40 according to an embodiment of the present invention. The light pointing touch panel display device 40 comprises a projection screen SCRN, an image projection unit PROJ, a light pointer LSIG, an image detecting unit FYCAM, an image processing unit IPU and a message transmitting unit SENDER. The image detecting unit FYCAM comprises a fisheye lens FYLENS and an optical filter FILTER. Firstly, the image projection unit PROJ is utilized to project a projected image PIC on the projection screen SCRN. The light pointer LSIG is utilized to emit a light spot signal of specific wavelength λ_{IR} on the projection screen SCRN. The fisheye lens FYLENS comprised in the image detecting unit FYCAM is utilized to collect light emanated from the image on the projection screen SCRN to generate a fisheye distorted image FUOI, and the optical filter FILTER is utilized to filter out the light except that of specific wavelength λ_{IR}. Furthermore, the image processing unit IPU is utilized to make calculations according to a position SPOS of the light spot on the projection screen SCRN made by the light pointer LSIG. Finally, the message transmitting unit SENDER is utilized to output a touch panel signal TPS according to the calculating result of the image processing unit IPU. Preferably, the wavelength λ_{IR} of the light spot signal is of infrared wavelength. And, preferably, the azimuthal angles of the fisheye lens FYLENS can go up to about 160 degrees, and is able to detect a complete picture of a projection screen of very large size. Noteworthily, the image detecting unit FYCAM can filter out all the optical signals except the light of wavelength λ_{IR}, and therefore the image detected by the image detecting unit FYCAM contains only the infrared signal emitted by the light pointer LSIG.

Since utilizing the fisheye lens FYLENS, the present invention is to correct the fisheye distorted image FYOI, such that the position SPOS of the light spot in the image PIC can be derived. This work is mainly executed by the image processing unit IPU. Please refer to FIG. 4C, which illustrates a schematic diagram of an image processing unit IPU according to an embodiment of the present invention. The image processing unit IPU of the light pointing touch panel display device 40 can further comprise a receiving unit RCVU, a recognition unit RGNU, a calculating unit CCLU and an output unit OUTU. The receiving unit RCVU is utilized to receive the fisheye distorted image FYOI. The recognition unit RGNU is utilized to determine the position SPOS according to a position FYPOS in the fisheye distorted image FYOI, and the position FYPOS is corresponding to a fisheye distorted coordinate FYOV. The calculating unit CCLU is utilized to calculate the fisheye corrected coordinate FYCV of the fisheye corrected image FYCI from the fisheye distorted coordinate FYOV according to a coordinate transfer function TF between the fisheye distorted image FYOI and the fisheye corrected image FYCI, wherein the fisheye corrected coordinate FYCV corresponds to the position SPOS (of the light spot) on the projection screen SCRN. Finally, the output unit OUTU is utilized to output a message comprising the fisheye corrected coordinate FYCV to a host computer HOST. Preferably, the coordinate transfer function TF comprises a fisheye correction coordinate transformation TFFY, a keystone correction coordinate transformation TFKS.

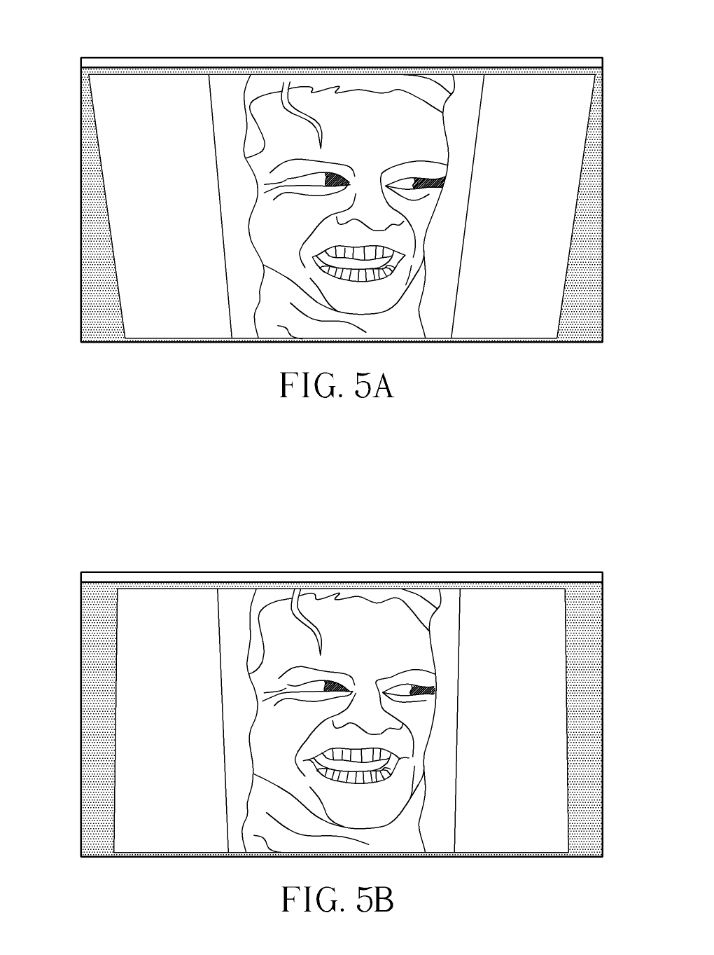

The coordinate transfer function TF comprises a fisheye correction coordinate transformation TFFY, a keystone correction coordinate transformation TFKS; except the keystone correction coordinate transformation TFKS, the rest of the transformations is equivalent to concept disclosed in the U.S. patent application Ser. No. 12/428,478. In the present invention, no need to output processing image, only need do coordinate transform. The present invention adds in the keystone correction coordinate transformation TFKS in the coordinate transfer function TF, such that the keystone distortion introduced during the image projection process can be corrected. Please refer to FIG. 5A, which illustrates a schematic diagram of an image before being corrected by the keystone correction coordinate transformation TFKS. The FIG. 5A demonstrates a phenomenon which is often seen in the real application of an ordinary projector, and one major feature of the said phenomena is the stretching of the image is not uniform in vertical and/or in horizontal directions. Please refer to FIG. 5B, which illustrates a schematic diagram of an image after being corrected by the keystone correction coordinate transformation TFKS. As can be observed from the FIG. 5B, the keystone correction coordinate transformation TFKS can further decrease the error introduced in the projection process, and improve the accuracy of the estimation result of the position of the light spot.

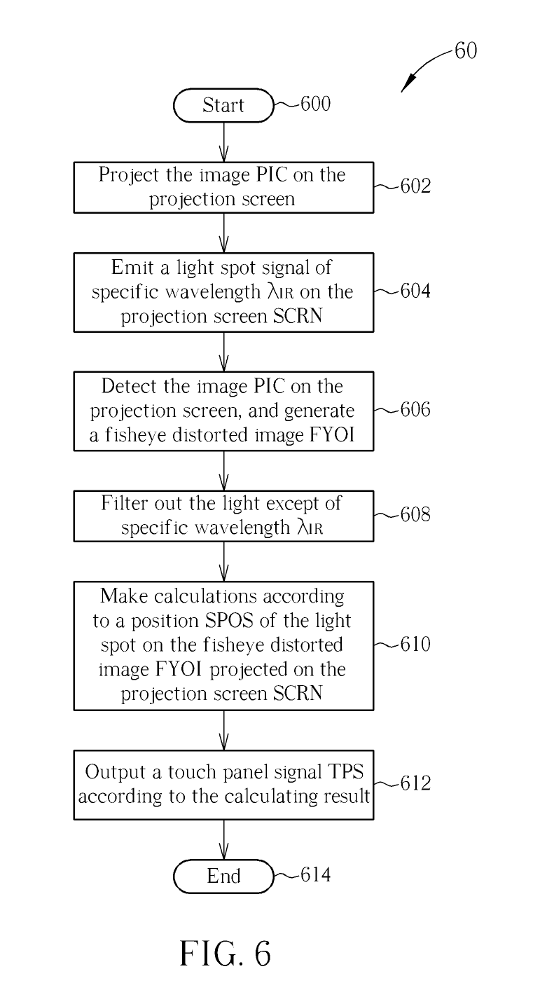

According to the architecture of the light pointing touch panel display device 40, a detecting method for a light pointing touch panel display device can be derived according to the present invention. Please refer to FIG. 6, which illustrates a schematic diagram of a light pointing touch panel detecting process 60 according to an embodiment of the present invention. The light pointing touch panel detecting process 60 comprises the following steps:

STEP 600: Start.

STEP 602: Project the image PIC on the projection screen.

STEP 604: Emit a light spot signal of specific wavelength λ_{IR} on the projection screen SCRN.

STEP 606: Detect the image PIC on the projection screen, and generate a fisheye distorted image FYOI.

STEP 608: Filter out the light except of specific wavelength λ_{IR}.

STEP 610: make calculations according to a position SPOS of the light spot on the fisheye distorted image FYOI projected on the projection screen SCRN.

STEP 612: output a touch panel signal TPS according to the calculating result.

STEP 614: End.

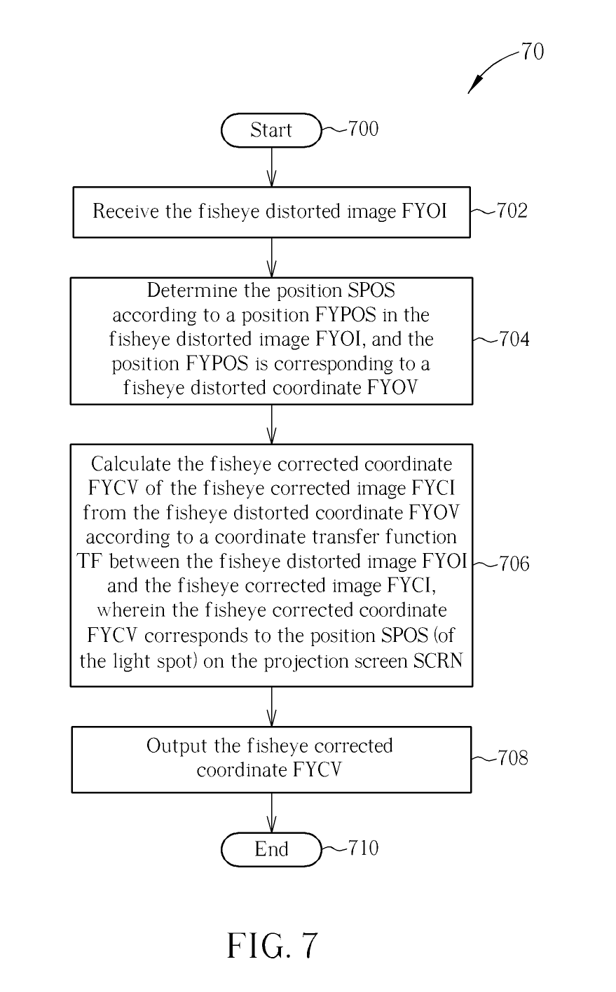

Furthermore, according to the architecture of the image processing unit IPU of the light pointing touch panel display device 40, a method can be derived to recognize and calculate the position of the light spot signal in the fisheye distorted image FYOI. Please refer to FIG. 7, which illustrates a process 70 utilized to calculate the position of the light spot SPOS on the fisheye corrected image FYCI according to the fisheye distorted image FYOI. The process 70 comprises the following steps:

STEP 700: Start.

STEP 702: Receive the fisheye distorted image FYOI.

STEP 704: Determine the position SPOS according to a position FYPOS in the fisheye distorted image FYOI, and the position FYPOS is corresponding to a fisheye distorted coordinate FYOV.

STEP 706: Calculate the fisheye corrected coordinate FYCV of the fisheye corrected image FYCI from the fisheye distorted coordinate FYOV according to a coordinate transfer function TF between the fisheye distorted image FYOI and the fisheye corrected image FYCI, wherein the fisheye corrected coordinate FYCV corresponds to the position SPOS (of the light spot) on the projection screen SCRN.

STEP 708: Output the fisheye corrected coordinate FYCV.

STEP 710: End.

The coordinate transfer function TF comprises a fisheye correction coordinate transformation TFFY, a keystone correction coordinate transformation TFKS. The operating principles of the transforms have been introduced above and in the U.S. patent application Ser. No. 12/428,478, and won't be detailed further.

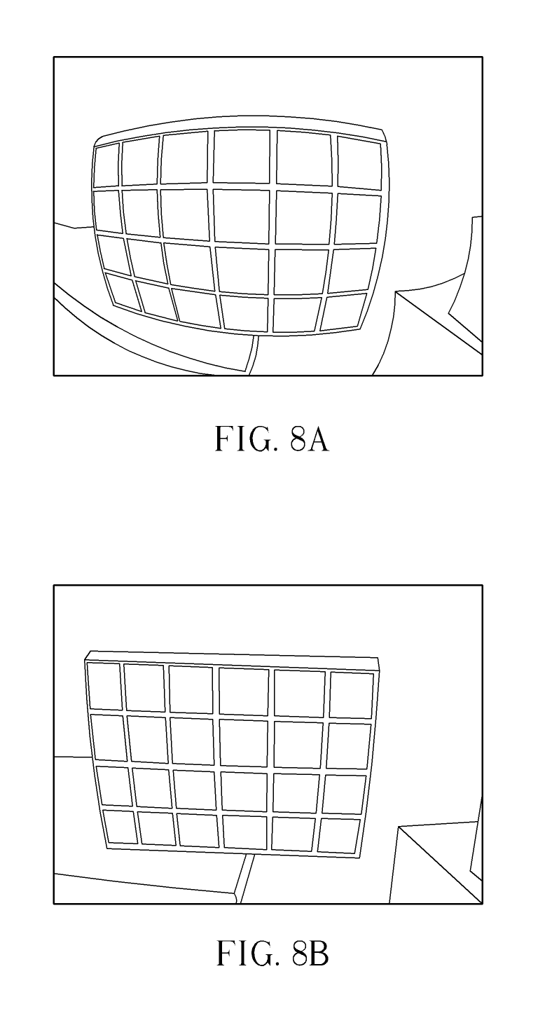

The light pointing touch panel detecting process 60 is operated according to the architecture of the light pointing touch panel display device 40, and is utilized to generate a touch panel signal TPS, which includes a coordinate FYCV in the fisheye corrected image FYCI, and the coordinate FYCV is derived by executing STEP 702 to STEP 706 as depicted in the process 70. As mentioned above, the small viewing angle camera NVCAM1 utilizes an ordinary camera lens, and this kind of lens can focus image on the camera sensor without introducing any obvious distortion and the proportional relationship of the objects in the object space can be kept in the detected image. Since there is only negligible distortion on the resulting image, the coordinate of the light spot can be calculated pretty straightforwardly. On the contrary, according to the design concept of the present invention, the image detecting unit FYCAM utilizes the fisheye lens FYLENS with its super wide viewing angle, such that a complete image PIC on the projection screen can be detected by the image detecting unit FYCAM. However, the price to be paid is the detected image will present various degrees of distortion and/or contraction by using the fisheye lens FYLENS. For example, Please refer to FIG. 8A, which illustrates a schematic diagram of a fisheye distorted image FYOI detected by the image detecting unit FYCAM. As can be observed, the object and scene in FIG. 8A was distorted by the fisheye lens FYLENS. Therefore, when the fisheye lens FYLENS is detecting a projected image containing a light spot, the light spot will also be “distorted” with the rest of the object and scene, and will experience a shift from its original location. The method of the prior art which is used for calculating the location of the light spot can no longer be useful to calculate the original location of the light spot. Please refer to FIG. 8B, which illustrates a fisheye corrected image FYCI, which is corrected according to process 70 by an image processing unit IPU, according to an embodiment of the present invention. By using the coordinate transformation function TF to correct the fisheye distorted image FYOI to the fisheye corrected image FYCI, when the light spot is located in any location in the fisheye distorted image FYOI, the image processing unit IPU can use the method depicted in the process 70 to calculate the corresponding position SPOS of the light spot in the fisheye corrected image FYCI.

Simply speaking, the present invention receives the fisheye distorted image, and detects the projection position of the light spot from the fisheye distorted image, wherein each projection position corresponds to a coordinate in the fisheye distorted image. Next, according to a coordinate transformation function between a fisheye distorted image and a fisheye corrected image, calculate the coordinate of the light spot in the fisheye corrected image from the coordinate in the fisheye distorted image, and output the coordinate in the fisheye corrected image. Then, this coordinate in the fisheye corrected image is the projection position of the light spot in the projected image. By this method, the touch panel function of the light pointing touch panel display device of the present invention can function normally.

To sum up, according to the present invention, the light pointing touch panel display device of the present invention and the related method is to utilize the fisheye lens to collect the infrared light spot signal in the projected image to detect the touch panel event and to inform the related host computer about the occurrence of the touch panel event. Also, according to the present invention, the user may use a large size of the projection screen, or a smaller size of projection screen (about 10 inches in diagonal), and when the projecting distance is small and requires a fisheye camera to detect the complete image, the method and apparatus introduced in the present invention can be utilized to perform the touch panel functions. Obviously, compared with the prior art, the present invention obviously provides more flexibility and can advance user's convenience.

Those skilled in the art will readily observe that numerous modifications and alterations of the device and method may be made while retaining the teachings of the invention.

What is claimed is:

1. A light pointing touch panel display device, which converts a display screen into a touch panel screen, comprising:
a projection screen;
an image projection unit for projecting an image on the projection screen;
a light pointer for emitting a light spot signal of a specific wavelength on the projection screen;
an image detecting unit, comprising:
a fisheye lens for receiving the image on the projection screen to generate a fisheye distorted image; and
an optical filter for filtering out the optical energy except the light spot signal of the specific wavelength;
an image processing unit, coupled to the image detecting unit, for calculating a first position of the light spot on the projection screen according to the fisheye distorted image; and
a message transmitting unit, coupled to the image processing unit, for outputting a touch panel signal according to the calculating result of the image processing unit.

2. The light pointing touch panel display device of claim 1, wherein the image processing unit further comprises:
a receiving unit for receiving the fisheye distorted image;
a recognition unit for determining the first position according to a second position having a fisheye distorted coordinate in the fisheye distorted image;
a calculating unit for calculating the fisheye corrected coordinate of the fisheye corrected image from the fisheye distorted coordinate according to a coordinate transfer function between the fisheye distorted image and the fisheye corrected image, wherein the fisheye corrected coordinate corresponds to the first position on the projection screen; and
an output unit for outputting the fisheye corrected coordinate.

3. The light pointing touch panel display device of claim 2, wherein the coordinate transfer function comprises a fisheye correction coordinate transformation, a keystone correction coordinate transformation.

4. The light pointing touch panel display device of claim 1, wherein the specific wavelength is of an infrared wavelength.

5. The light pointing touch panel display device of claim 1, wherein the maximal azimuthal angle of the fisheye lens between 120 to 160 degrees.

6. The light pointing touch panel display device of claim 2, wherein the touch panel signal comprises the fisheye corrected coordinate.

7. A light pointing touch panel detecting method, which is utilized for converting a display screen into a touch panel screen, comprising:
projecting an image on a projection screen;
emitting a light spot signal of a specific wavelength on the projection screen;
receiving the image on the projection screen to generate a fisheye distorted image;
filtering out optical energy except the light spot signal of the specific wavelength;
calculating a first position of the light spot on the projection screen according to the fisheye distorted image; and
outputting a touch panel signal according to the calculating result of the image processing unit.

8. The light pointing touch panel detecting method of claim 7, wherein calculating the first position of the light spot on the projection screen according to the fisheye distorted image comprises:
receiving the fisheye distorted image;
determining the first position according to a second position having a fisheye distorted coordinate in the fisheye distorted image;
calculating the fisheye corrected coordinate of the fisheye corrected image from the fisheye distorted coordinate according to a coordinate transfer function between the fisheye distorted image and the fisheye corrected image, wherein the fisheye corrected coordinate corresponds to the first position on the projection screen; and
outputting the fisheye corrected coordinate.

9. The light pointing touch panel detecting method of claim 8, wherein the coordinate transfer function comprises a fisheye correction coordinate transformation, a keystone correction coordinate transformation.

10. The light pointing touch panel detecting method of claim 7, wherein the maximal azimuthal angle of the fisheye lens is between 120˜160 degrees.

11. The light pointing touch panel detecting method of claim 8, wherein the touch panel signal comprises the fisheye corrected coordinate.
